(19) United States
(12) Patent Application Publication
(10) Pub. No.: US 2014/0100862 A1
(43) Pub. Date: Apr. 10, 2014

(54) System and method for real time adjudication and payment of health care claims

(71) Applicant: Merlyn Sollano, Toronto (CA)

(72) Inventor: Merlyn Sollano, Toronto (CA)

(21) Appl. No.: 13/998,780

(22) Filed: Dec. 5, 2013

Related U.S. Application Data
(63) Continuation of application No. PCT/CA2012/000563, filed on Jun. 8, 2012.
(60) Provisional application No. 61/500,158, filed on Jun. 23, 2011.

(51) Int. Cl. G06F 19/00

(52) U.S. Cl. CPC G06F 19/328
USPC 705/2

(57) ABSTRACT

A method of claims adjudication which includes the steps of a service provider submitting a claim online at an adjudicators website. The service provider inputting data required by online prompts. Real time online analysis and adjudication of input data and claim to determine if claim meets the adjudicator's preselected criteria. If the claim is accepted, a payment will issue, otherwise if the claim is denied the user is notified of the denial. The method further includes the step of issuing a credit/insurance card to a user wherein the credit/insurance card is adapted to receive payment at a point of sale terminal.

This application is a continuation of International Application No. PCT/CA2012/000563 titled SYSTEM AND METHOD FOR REAL TIME ADJUDICATION AND PAYMENT OF HEALTH CARE CLAIMS filed Jun. 8, 2012 by Merlyn Sollano, which claims priority from previously filed U.S. Provisional Patent Application No. 61/500,158, titled SYSTEM AND METHOD FOR REAL TIME ADJUDICATION AND PAYMENT OF HEALTH CARE CLAIMS filed Jun. 23, 2011 by Merlyn Sollano.

### FIELD OF THE INVENTION

The present concept relates to systems and methods for adjudication and payment of healthcare claims more particularly a real time system and method of adjudication of payment of healthcare claims.

### BACKGROUND OF THE INVENTION

Health care costs comprise an increasing and disproportionate share of the world economic output. There have been many factors identified as leading to these increases in costs and one such factor is the administrative costs in delivering and billing for health care services.

There is a need for a system and method for real time adjudication and payment of healthcare claims which automates adjudication in payment of healthcare claims to the maximum extent thereby reducing administrative time involved with the adjudication and payment of healthcare claims and therefore reducing the overall cost of the delivery of the health care.

### SUMMARY OF THE INVENTION

A method of claims adjudication which includes the steps of:
a) a service provider submitting a claim online at an adjudicators website,
b) the service provider inputting data required by online prompts,
c) real time online analysis and adjudication of input data and claim to determine if claim meets the adjudicator's preselected criteria,
d) if the claim is accepted a payment will issue,
e) if the claim is denied the user is notified of the denial.

Perferrably further including the step of issuing a credit/insurance card to a user.

Perferrably wherein if the claim is accepted the users credit/insurance card is credited with payment to be used to pay service provider.

Perferrably wherein if the claim is denied an email is sent to user and no funds are transferred.

Perferrably wherein the credit/insurance card is adapted to receive payment at a point of sale terminal.

Perferrably wherein the credit/insurance card is loaded with payment that is revoked after a preselected amount of time.

Perferrably wherein if the claim is accepted payment is electronically transferred into the user's bank account.

Perferrably wherein if the claim is accepted the user is given a preselected amount of time to load the card with payment at a point of sale terminal.

Perferrably wherein the preselected amount of time is fifteen minutes.

Perferrably wherein users claim history can be output in preselected formats in real time.

Perferrably wherein the user can output in real time the amount of funding left in a user's health spending account.

Perferrably wherein the adjudicator is adapted to calculate the payment liability from multiple sources and allocate payment from multiple sources based on preselected criteria.

Perferrably wherein if the claim is accepted payment will issue from multiple sources.

Perferrably wherein the credit/insurance card is adapted to receive payment at a point of sale terminal by inputting the card multiple times at the point of sale terminal to receive multiple payments from multiple sources.

Preferrably wherein the service provider being a medical provider capable to make a diagnosis and prescribe treatment.

### BRIEF DESCRIPTION OF THE DRAWINGS

The concept will now be described by way of example only with reference to the drawings in which;

FIG. 1 is a flow chart depicting a healthcare provider example showing the system and method for real time adjudication and payment of healthcare claims.

FIG. 2 is a flow chart depicting an employee home claim example for a system and method for real time adjudication and payment of healthcare claims.

### DETAILED DESCRIPTION OF THE PREFERRED EMBODIMENTS

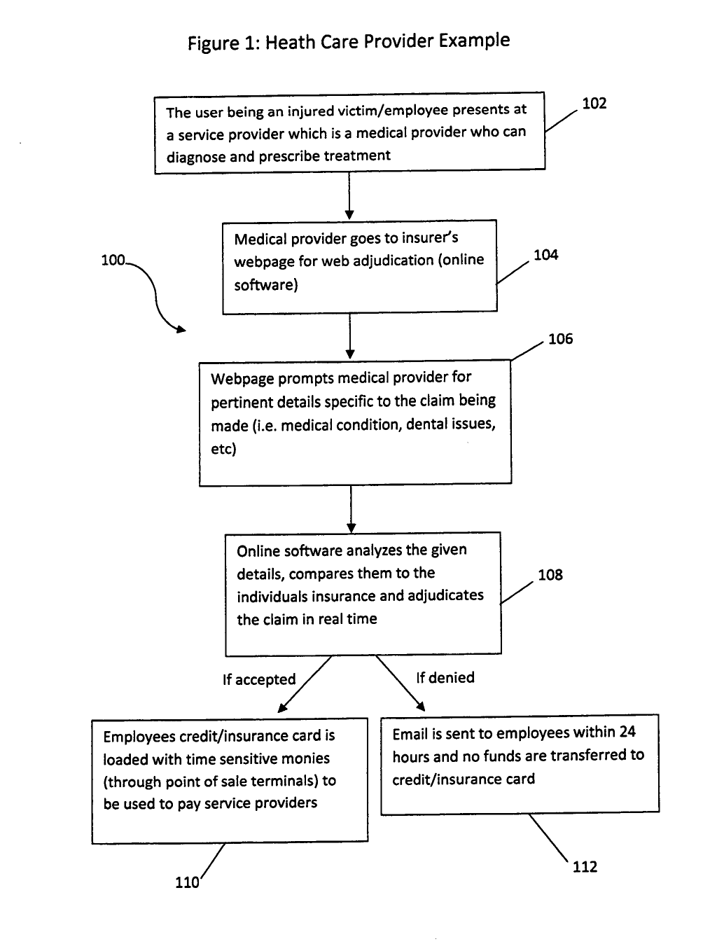

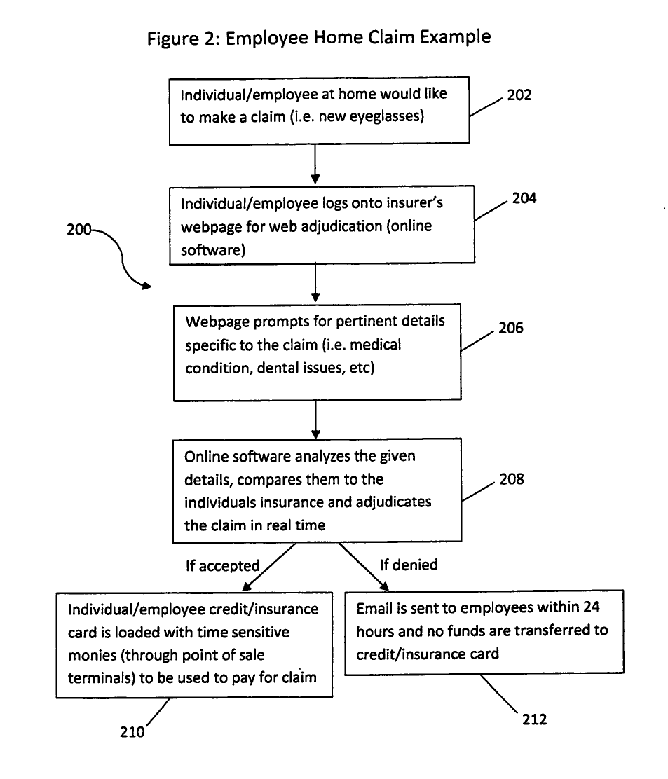

The present system and method for real time adjudication and payment of health care claims is depicted in FIGS. 1 and 2 generally denoted as 100 and 200 respectively.

In this application the following terms have the following meaning:
a) “Service provider” can be an individual or organization which provides certain services or goods to the user. Examples of service providers include medical doctors providing medical services, chiropractors, physiotherapists, opticians, automobile body repair shops, pharmacies, or may also be the user in the case where the user makes a claim directly for example for a brace
b) “User” can be an individual or organization that is making a claim and normally is an injured victim or an employee. This may for example be an insured person or corporation. The user is generally speaking seeking compensation in some form by making a claim that needs to be adjudicated.
c) “health spending account” is a real or notional account of monies that are available to a user for compensation payment against a claim. The account may have attached to it numerous restrictions including maximum or reimbursement caps on certain or all claims.
d) “credit/insurance card” is a credit card like device which is capable of being electronically loaded or credited with monies at a point of sale terminal. These monies can be used to pay a service provider.

Referring now to FIG. 1 which shows a health care provider example shown generally as 100 which includes the following steps:

Step 1 shown generally as 102 a user which in this example is an injured victim will present at a service provider which in this case is a medical provider who is in a position to make a diagnosis and prescribe treatment.

Step 2 shown as 104 is the step in which the medical provider will access the insurer webpage for real time web adjudication of the medical condition. The insurer webpage will contain online software to allow adjudication of the claim.

Step 3 shown as 106 is an interactive web portal in which the medical provider will access a webpage wherein online software prompts for pertinent details specific to the claim being made. The medical provider will input information as requested by the online software. The claim may be for a medical condition, it may be for a dental condition, it may be for prescription eye glasses or any other claim which is available under the insurance program.

Step 4 shown as 108 in FIG. 1 is a step in which the online software analyses the details which were input by the medical provider and compares them to the individuals insurance coverage and adjudicates the claim in real time. In the case where the software has not received enough pertinent information to make an adjudication it will prompt for further information required. Once enough information has been received by the software to make an adjudication either to accept or deny a claim the system and method will move to the next step.

Step 5 shown as 110 is the condition wherein the claim is accepted by the online software program which is run by the insurer or third party administrator. In the case where the claim is accepted the victims or patients credit and/or insurance card is loaded with time sensitive money through a point of sale terminal to be used to pay the service providers. The victim and/or patient will swipe his or her card or input his or her card into a chip reader and the insurer or third party administrator will automatically load the card with a predetermined amount of money in accordance with the acceptance of the claim which was made.

The victim and/or patient can then use this money within a certain allotted period of time in order to pay the delivery of the medical treatment.

In step 6 shown as 112 in FIG. 1 if the claim is denied an email is sent out by the insurer or third party administrator to the employee, victim and/or patient within 24 hours that no funds are transferred to their credit/insurance card and that the claim has been denied.

Referring now to FIG. 2 which is an example of an employee home claim utilizing the system and method for real time adjudication and payment of health care claims shown generally as 200.

In step 1 shown as 202 the user in this example is an individual or employee which is at home and would like to make a claim for example for new eyeglasses.

In step 2 shown as 204 the individual/employee logs onto the insurer's webpage for web adjudication using their online software.

Step 3 shown as 206 the insurers online software prompts the individual/employee for pertinent details specific to the claim that the individual/employee is making for example for eyeglasses.

In step 4 shown as 208 the insurer's online software prompts for more information if not enough information is input in order to make an adjudication and/or once enough information is received by the online software it analyses the given details and compares them to the individual/employees insurance benefits and adjudicates the claim in real time.

Step 5 shown as 210 in FIG. 2 the insurer's software will load the individual/employees credit/insurance card through a point of sale terminal with time sensitive money which can be used to pay for the claim such as eyeglasses. The individual can then proceed to purchase the eyeglasses through their supplier and present their credit/insurance card for payment of their new eyeglasses.

Step 6 is the case where the claim is denied shown as 212 in which case the insurers software will send an email to the individual/employee within 24 hours and inform them that no funds are being transferred to their credit/insurance card and that the claim has been denied.

The reader will note that this system and method for real time adjudication payment of health care claims has the ability to reduce the time for claims payment processing, provides for real time adjudication of claims and allows for real time payment of claims.

In addition this system and method for real time adjudication for payment and health care claims provides better controls for employee expenses, provides automated security features and often will result in increased employee support and satisfaction.

It should be apparent to persons skilled in the arts that various modifications and adaptation of this structure described above are possible without departure from the spirit of the invention the scope of which defined in the appended claim.

I Claim:

1) A method of claims adjudication which includes the steps of:
a) issuing an electronically loadable credit/insurance card to the user, which is electronically loadable with monies at a point of sale terminal,
b) a service provider submitting a claim online at an adjudicators website on behalf of a user,
c) the service provider inputting data required by online prompts,
d) real time online analysis and adjudication of input data and claim to determine if the claim meets the adjudicator's preselected criteria,
e) if the claim is accepted, money to pay the claim is loaded onto the credit/insurance card which can be used to pay the claim amount,
f) if the claim is denied the user is notified of the denial.

2) (canceled)

3) The method claimed in claim 1, further including the step of provided the claim is accepted, crediting the user's health spending account with the entire amount accepted to be paid.

4) The method claimed in claim 1, wherein if the claim is denied an email is sent to user and no funds are transferred.

5) The method claimed in claim 3, wherein the amounts loaded onto the credit insurance card are deducted from the total in the user's health spending account.

6) The method claimed in claim 3, wherein the credit/insurance card is loaded with payment that is revoked after a preselected amount of time.

7) The method claimed in claim 1 wherein if the claim is accepted payment is electronically transferred into the user's bank account.

8) The method claimed in claim 6, wherein if the claim is accepted the user is given a preselected amount of time to load the insurance/credit card with payment at a point of sale terminal.

9) The method claimed in claim 8 wherein the preselected amount of time is fifteen minutes.

10) The method claimed in claim 1 wherein users claim history can be output in preselected formats in real time.

11) The method claimed in claim 10 wherein the user can output in real time the amount of funding left in a user's health spending account.

12) The method claimed in claim 3 wherein the adjudicator is adapted to calculate the payment liability from multiple sources and allocate payment from multiple sources based on preselected criteria.

13) The method claimed in claim 12 wherein if the claim is accepted payment will issue from multiple sources, and the user's health spending account will be credited with the amounts.

14) The method claimed in claim 13 wherein the credit/insurance card is adapted to receive payment at a point of sale terminal by inputting the card multiple times at the point of sale terminal to receive multiple payments from multiple sources.

15) The method claimed in claim 1 wherein the service provider being a medical provider capable to make a diagnosis and prescribe treatment.
